(19) United States
(12) Patent Application Publication
(10) Pub. No.: US 2023/0072591 A1
(43) Pub. Date: Mar. 9, 2023

(54) SERVICE PRICING DEVICES AND SERVICE PRICING METHOD

(71) Applicant: GRABTAXI HOLDINGS PTE. LTD., Singapore (SG)

(72) Inventors: Weili YAN, Singapore (SG); Wentong LI, Singapore (SG)

(21) Appl. No.: 17/799,181

(22) PCT Filed: Feb. 11, 2020
(86) PCT No.: PCT/SG2020/050066

§ 371 Date: Aug. 11, 2022

(51) Int. Cl. G06Q 30/02; G06Q 10/06; G06Q 50/30

(52) U.S. Cl. CPC G06Q 30/0206; G06Q 10/063114; G06Q 50/30

(57) ABSTRACT

Aspects concern service pricing device, comprising a receiving unit configured to receive service orders over a communication network from a plurality of customers requesting a service from a service provider in a predetermined area and in a time period; an allocation unit configured to determine a current allocation rate of received service orders among a plurality of service contractors and to allocate received service orders to the plurality of service contractors; and a pricing unit configured for determining a current price for a service order received in the time period for the predetermined area based on the current allocation rate of service orders and a predetermined allocation rate of service orders for the plurality of service contractors, and a notification unit configured to provide the current price of the service over the communication network to the plurality of customers and to the plurality of service contractors such that a service order for the predetermine area and in the time period is fulfilled at the determined current price.

### TECHNICAL FIELD

Various aspects of this disclosure relate to data processing systems related to a service pricing devices.

### BACKGROUND

A current dynamic pricing system for a transport fee in a passenger transport uses a multiplicative mechanism for the surge adjustment, i.e. dynamic pricing multiplier. Thus, the surge in a next step (time period) is equal to the multiplication of the surge in a current step (time period) and a multiplier. The multiplier is derived based on the current supply/demand of transport service to conditions. However, this mechanism may cause several issues. For example, when the surge value in the current step is large, the surge value in the next step could be very high if the multiplier is slightly bigger than one. Meanwhile, during the peak hours of passenger transport, the value of the multiplier oscillates frequently around one, which could make the price change drastically for the same pick-up/drop-off location of the passenger transport within a short time period. Such phenomenon may lower passengers' confidence in the pricing mechanism of the passenger transport service provider.

### SUMMARY

Various embodiments concern service pricing devices and a service pricing method.

In one aspect of the disclosure, a service pricing device is provided. The service pricing device includes a receiving unit configured to receive service orders over a communication network from a plurality of customers requesting a service from a service provider in a predetermined area and in a time period; an allocation unit configured to determine a current allocation rate of received service orders among a plurality of service contractors and to allocate received service orders to the plurality of service contractors, and a pricing unit configured for determining a current price for a service order received in the time period for the predetermined area based on the current allocation rate of service orders and a predetermined allocation rate of service orders for the plurality of service contractors, and a notification unit configured to provide the current price of the service over the communication network to the plurality of customers and to the plurality of service contractors such that a service order for the predetermined area and in the time period is fulfilled at the determined current price.

In another aspect, a service pricing device including: one or more processor(s); and a memory having instructions stored therein, the instructions, when executed by the one or more processor(s), cause the one or more processor(s) to: receive service orders over a communication network from a plurality of customers requesting a service from a service provider in a predetermined area and in a time period; determine a current allocation rate of received service orders among a plurality of service contractors and allocate received service orders to the plurality of service contractors; determining a current price for a service order received in the time period for the predetermined area based on the current allocation rate of service orders and a predetermined allocation rate of service orders for the plurality of service contractors, and provide the current price of the service over the communication network to the plurality of customers and to the plurality of service contractors such that a service order for the predetermined area and in the time period is fulfilled at the determined current price.

In another aspect, a service pricing method includes receiving service orders over a communication network from a plurality of customers requesting a service from a service provider in a predetermined area and in a time period; determining a current allocation rate of received service orders among a plurality of service contractors and allocate received service orders to the plurality of service contractors, determining a current price for a service order received in the time period for the predetermined area based on the current allocation rate of service orders and a predetermined allocation rate of service orders for the plurality of service contractors, and providing the current price of the service over the communication network to the plurality of customers and to the plurality of service contractors such that a service order for the predetermined area and in the time period is fulfilled at the determined current price.

Illustratively, in various aspects, the surge of time dependent pricing of the service may be configured as a feedback control problem and control theory may be applied to generate the surge value automatically using the real-time supply/demand information. The supply information is characterized by the occupancy rate which defines the percentage of service contractors who are occupied and the demand information is characterized by the allocation rate which indicates the percentage of customers who get allocated. The controller is configured to generate the surge such that the allocation rate and occupancy rate are controlled at a target level. As such, the majority of service contractors are able to receive service orders while the majority of customers can be allocated.

The time period may be a continuous time period, e.g. one hour. The service is a real space service fulfilled in real space. Thus, a real space service is not meant to be a pure communication service, as example. However, the real space service demand may be communicated over a communication network. As example, a real space service may be a delivery service of a commodity, e.g. a food delivery service or (express) courier service, wherein the service order for the real space service is generated and received by (mobile) communication devices.

In various aspects, the quantity of data to be processed is reduced since service contractors do not have to be organized, commissioned (e.g. the quantity of required delivery drivers) or repositioned on short notice compared to a scenario in which an unexpected high real space service demand suddenly occurs and has to be handled by the service provider organizing the tour and commission of each of the service contractors. This way, memory organization and network efficiency of the service provider is increased. In addition, experience of customers of the real space service demand is increased. In other words, the better pricing of a (future) real space service order may decrease a communication demand compared to a scenario in which no feedback controlled pricing is given.

### BRIEF DESCRIPTION OF THE DRAWINGS

The invention will be better understood with reference to the detailed description when considered in conjunction with the non-limiting examples and the accompanying drawings, in which:

FIG. 1 shows in a schematic diagram a service pricing device according to various embodiments;

FIG. 2 shows a flow diagram of a service pricing method according to various embodiments;

FIG. 3 shows a control diagram of a pricing method according to various embodiments, and

FIG. 4 shows simulation results of an implementation of a pricing method according to various embodiments.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the enclosure assemblies, vehicles, or demand notification methods are analogously valid for the other enclosure assemblies, vehicles, or demand notification methods. Similarly, embodiments described in the context of an enclosure assembly are analogously valid for a vehicle or a demand notification method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

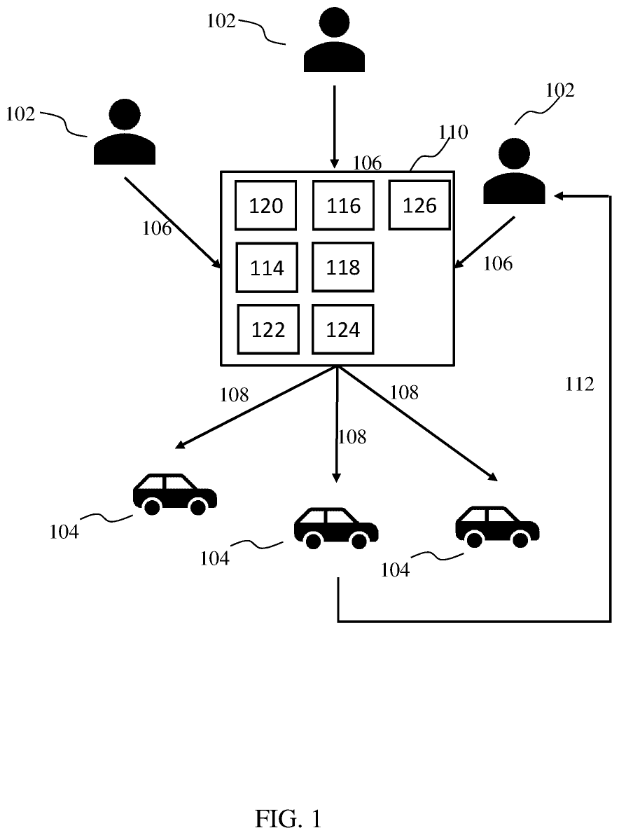

FIG. 1 illustrates in a schematic diagram a service pricing device 110 according to various embodiments. The service pricing device 110 may include a receiving unit 120, an allocation unit 122, a pricing unit 114, a notification unit 124, one or more processors 116; and a memory 118.

A plurality of customers 102 submits service orders 106 to a service provider 110. The service provider receives the service orders 106, processes them and allocates the processed service orders 108 to a plurality of subcontractors 104. Each of the subcontractors 104 is fulfilling one processed service order 108. Thus, the service order 106 of a customer 102 is fulfilled (illustrated in FIG. 1 as fulfilled service 112).

As example, the customer 102 may be a passenger of an on-demand or personalized passenger transport service provider hailing 106 a driver (service contractor) 104 for transportation from a first location, e.g. location of the customer 102, to a second location, e.g. destination of the customer 102. Thus, fulfilling the passenger transport service order 106 by the driver 104 is the fulfilled passenger transport 112.

In another example, the customer 102 may place a food service order 106, e.g. via a (mobile) communication device, to be delivered to the location of customer by a food delivery service 110. The ordered food is delivered from a restaurant (first location) to the ordering customer (second location) by a delivery driver (service contractor) 104. Thus, fulfilling the food delivery order 106 by the delivery driver 104 is the fulfilled food delivery 112.

In yet another example, the customer 102 may place a postal courier order 106, e.g. via a (mobile) communication device, to be delivered to another location by a postal courier service 110. The postal, e.g. a message or package, is delivered from a first location, e.g. the location of the customer 102, to a second location, e.g. location of receiver of the package or message, by a postal courier 104. Thus, fulfilling the postal courier order 106 by the postal courier (driver) 104 is the fulfilled postal courier (service) 112.

Thus, the location and the “commodity” to be transported may vary depending on the kind of service 112.

The price (also denoted as fee or fare) for the transport service (fulfillment of the ordered service 112) is set or determined by the transport service provider 110. The price for the service 112 may be dynamically adapted by the service provider 110. That is, the pricing of the service 112 may be adapted by the service provider based on ambient conditions. The price may vary depending on supply of service contractors (drivers) 104 and quantity of service orders 106 (demand), as example. The price for the service 112 set by the service provider is effective or valid for all drivers 104 of the plurality of drivers that are unoccupied (open for fulfilling a new service order 108) in a predetermined service area of the drivers 104, e.g. a city or district of a city, and in a predetermined time period for which the current price is valid (e.g. the next 1 min, the next 5 min etc.) for the (next) customer 102.

As example, there may be a high demand time period in which a large quantity of service 112 is requested (106) and/or a large quantity of drivers 104 is already occupied with fulfilling processed service orders 108. Thus, the price for fulfilling another service order 106 within the same time period may be relatively high since the quantity of drivers 104 available for fulfilling the service order is low. In addition, the time period in which the offered price for the service 112 is valid may be relatively short, e.g. in a range from about 30 sec to about 5 min, as examples.

As example, there may be a low demand time period in which a small quantity of service is requested (106) and/or a large quantity of drivers 104 is available (unoccupied) with fulfilling processed service orders 108. Thus, the price for fulfilling another service order 106 within the same time period may be relatively low since the quantity of drivers 104 available for fulfilling the service order is high. In addition, the time period in which the offered price for the service 112 is valid may be relatively long, e.g. in a range from about 5 min to about 30 min, as examples.

The service provider may include or host the pricing unit 114. The pricing unit 114 may be implemented by the one or more processors 116 and the memory 118 or may be communicatively coupled to the one or more processors 116 and the memory 118. The service provider may include or host the one or more processors 116 and the memory 118. The pricing unit 114 is configured to determine or set a price for the service 112 and submit the price to the customer 102 and the service contractor 104. The price has to be paid by the customer 102 of the next order for the service 112 in the predetermined area and the time period. The price may further determine the margin for the service contractor 104 fulfilling the service 112 and/or the service provider.

The pricing unit 114 may consider the current price, the supply of drivers 104 and the demand of service (service orders 106). The pricing unit 114 may be configured for price determination, price matching, brokerage, price balancing and/or settlement for the service 112.

The pricing unit 114 may include a feedback and/or closed loop system. The pricing unit 114 may be configured to determine a fair market value for the service 112 for the plurality of (unoccupied) drivers 104.

The predetermined area may be a geohash code area, a postal code area or a radio cell area. The time period has a period length in a range from 30 sec to about 2 h. The time period may be adjustable. The service 112 may be a real space service. Each service order 106 may be configured as an electronic message submitted via a communication network.

The receiving unit 120 may be configured to receive service orders 106 over a communication network from the plurality of customers 102 requesting the service 112 from the service provider in a predetermined area and in a time period. The receiving unit 120 may include a communication device that may be configured to receive the electronic messages including the service orders 106 via a communication connection through the communication network.

The allocation unit 122 may be configured to determine a current allocation rate of received service orders 106 among a plurality of service contractors 104 and to allocate received service orders 106 to the plurality of service contractors 104. The service provider may include or host the allocation unit 122. The allocation unit 122 may be implemented by the one or more processors 116 and the memory 118 or may be communicatively coupled to the one or more processors 116 and the memory 118.

Alternatively or in addition to the allocation unit 122, there may be an occupancy unit 126 configured to determine a current occupation rate of service contractors 104 of the plurality of service contractors 104 currently not available for accepting a service order 108 among the plurality of service contractors 104. The service provider may include or host the allocation unit 122. The allocation unit 122 may be implemented by the one or more processors 116 and the memory 118 or may be communicatively coupled to the one or more processors 116 and the memory 118.

The pricing unit 114 may further be configured for determining the current price for the service order 106 received in the time period for the predetermined area based on the current occupation rate of service contractors 104 and the predetermined occupation rate for service contractors 104. The pricing unit 114 may be configured for determining a current price for a service order 106 received in the time period for the predetermined area based on the current allocation rate of service orders 106 and a predetermined allocation rate of service orders 106 for the plurality of service contractors 104. Alternatively or in addition, the pricing unit 114 may be configured for determining the current price for the service order received in the time period for the predetermined area based on the current occupation rate of service contractors 104 and a predetermined occupation rate for service contractors 104.

The notification unit 124 may be configured to provide the current price of the service 112 over the communication network to the plurality of customers 102 and to the plurality of service contractors 104 such that a service order for the predetermined area and in the time period may be fulfilled at the determined current price. The notification unit 124 may include a communication device that may be configured to transmit the determined current price for the service via communication connections through the communication network to the plurality of customers 102 and to the plurality of service contractors 104.

The one or more processors 116 may be configured to host the allocation unit 122, the occupancy unit 126 and/or the pricing unit 114. Alternatively, one or more application specific integrated circuit (ASIC) may be included that may be configured to host the allocation unit 122 and the pricing unit 114.

The memory 118 may have instructions stored therein, the instructions, when executed by the one or more processors 116, cause the one or more processors 116 to receive service orders 106 over a communication network from a plurality of customers 102 requesting a service 112 from a service provider in a predetermined area and in a time period; determine a current allocation rate of received service orders among a plurality of service contractors 104 and allocate received service orders to the plurality of service contractors 104; determining a current price for a service order 106 received in the time period for the predetermined area based on the current allocation rate of service orders and a predetermined allocation rate of service orders for the plurality of service contractors 104, and provide the current price of the service 112 over the communication network to the plurality of customers 102 and to the plurality of service contractors 104 such that a service order 106 for the predetermined area and in the time period may be fulfilled at the determined current price.

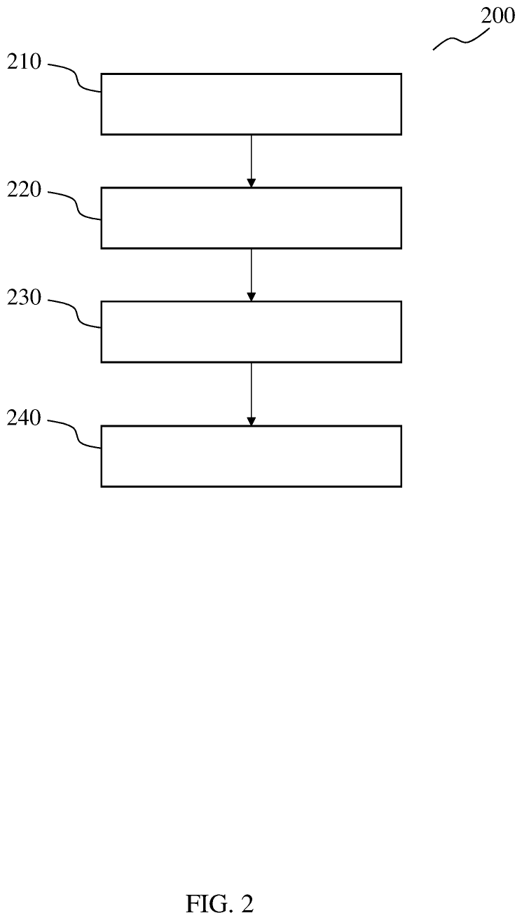

FIG. 2 illustrates a flow diagram of a service pricing method 200 according to various embodiments. The method includes receiving 210 service orders 106 over a communication network from a plurality of customers 102 requesting a service 112 from a service provider in a predetermined area and in a time period; determining 220 a current allocation rate of received service orders among a plurality of service contractors 104 and allocate received service orders to the plurality of service contractors 104; determining 230 a current price for a service order received in the time period for the predetermined area based on the current allocation rate of service orders and a predetermined allocation rate of service orders for the plurality of service contractors 104, and providing 240 the current price of the service over the communication network to the plurality of customers 102 and to the plurality of service contractors 104 such that a service order 106 for the predetermined area and in the time period is or will be fulfilled at the determined current price.

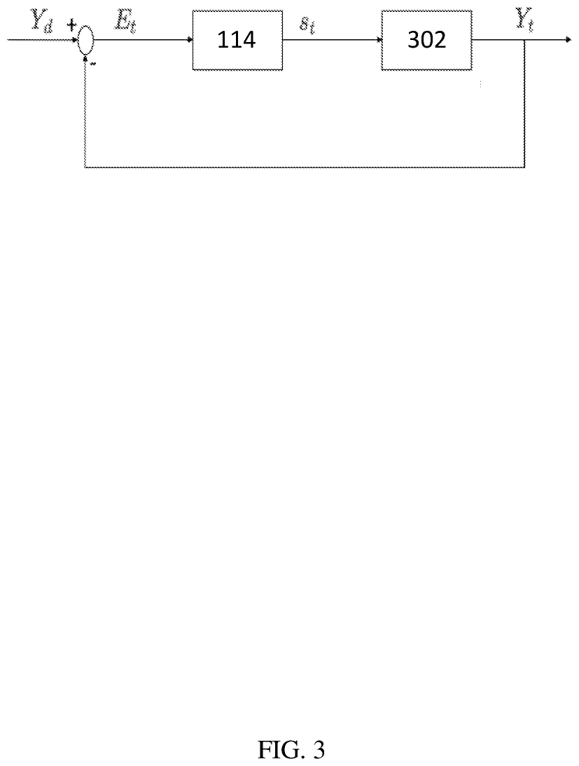

FIG. 3 illustrates a control diagram of the service pricing method according to various embodiments. FIG. 3 illustrates the pricing by the pricing unit of the service provider according to various embodiments. The pricing is illustrated using the example of a transport service provided by a transport service provider 110, e.g. passenger transport or commodity transport, and implemented by a plurality of transport drivers 104—see FIG. 1.

Here, P_{target} is a vector consisting of the real-time allocation rate of transport service orders 108 and occupancy rate of drivers 104. Illustratively, the pricing unit 114 of the service provider for the price of the service 112 may function like a controller. The pricing unit 114 is applied to the environment of the service provider 110, e.g. the ride-hailing market. The observed allocation rate and occupancy rate are considered as the controlled variable whose values are feedback to the pricing unit. Thus, the price for the service 112 may reach a target price, e.g. a fair market value, with a reasonable speed and an acceptable robustness. Meanwhile, the surge oscillation issue of the pricing may be solved during the configuration of the pricing unit 114.

In the following, high level description of the pricing unit configuration based on a “control problem approach” is provided. Provided a discrete market model (city level or geohash level) as

Pₜ₊₁=f(Pₜ,sₜ)

with Sₜ as the surge value of the price for the service 112 at time period t,Pₜ=[P_{allocation}; P_{occupancy}] a vector consisting of allocation rate of service orders 106 and occupancy rate of drivers 104 with specified initial conditions as Pₜ_{₀}=[P_{allocation,t}_{ₒ}; P_{occupancy,t}_{ₒ}]

In the pricing unit 114, the following cost function is minimized:

U=Σₜ₌ₜ_{₀}^{t=inf}(Pₜ−P_{target})^{T}Q(Pₜ−P_{target})

where Q is a positive definite weight matrix. Thus, the pricing unit 114 is configured to determine the controller sₜ₊₁=g(Pₜ) which can minimize the cost function U. As example, for each predetermined area—e.g. having the same geohash code, the upstream system 302 (e.g. the system administrating supply of drivers 104 and demand of service) may provide real-time supply/demand signals as well as smoothed (e.g. by a moving average) supply/demand signals. These signals may be updated every one minute.

As example, Dₜ,Dₜ^{smooth} sₜ, sₜ^{smooth} denote the demand, smoothed demand, supply and smoothed supply at time period t, respectively. Each of these signals can be further decomposed into two parts: met signal and unmet signal, that is

Dₜ=Dₜ^{met}+Dₜ^{unmet}

Sₜ=Sₜ^{met}+Sₜ^{unmet}

Dₜ^{smooth}=Dₜ^{smoothed_met}+Dₜ^{smoothed_unmet}

Sₜ^{smooth}=Sₜ^{smoothed_met}+Sₜ^{smoothed_unmet}

From these signals, a first signal and a second signal may be derived. The first signal may be the allocation rate represented by yₜ^{a} and the second signal may be occupancy rate represented by yₜ⁰:

$${y}_{t}^{a} = \frac{{D}_{t}^{smoothed \_ met}}{{D}_{t}^{smoothed \_ met} + {D}_{t}^{smoothed \_ unmet}} = \frac{{D}_{t}^{smoothed \_ met}}{{D}_{t}^{smooth}}$$

$${y}_{t}^{o} = \frac{{S}_{t}^{smoothed \_ met}}{{S}_{t}^{smoothed \_ met} + {S}_{t}^{smoothed \_ unmet}} = \frac{{S}_{t}^{smoothed \_ met}}{{S}_{t}^{smooth}}$$

Here, sₜ may denote the surge value applied on the price for the service 122 for a predetermined area (e.g. having the same geohash code) at time period t. The surge function algorithm aims to configure sₜ such that yₜ^{a} and yₜ^{o} follow y_{d}^{a} and y_{d}^{o} as closely as possible. Here, y_{d}^{a} and y_{d}^{o} denote a desired or intended allocation rate and occupancy rate, respectively.

In various embodiments, a proportional-integral-derivative (PID) control method may be applied to configure the surge sₜ.

As example, eₜ^{a} and eₜ^{o} may denote a difference between the desired allocation/occupancy rate and the actual allocation/occupancy rate at time period t, respectively. Therefore,

eₜ^{a}=y_{d}^{a}−yₜ^{a}

eₜ^{o}=y_{d}^{o}−yₜ^{o}

define Yₜ=[yₜ^{a},yₜ^{o}]^{T}∈ [symbol] ², Y_{d}=[y_{d}^{a},y_{d}^{o}]^{T}∈ [symbol] ²(see also FIG. 3)

Thus, Eₜ (see FIG. 3) may be

Eₜ=Y_{d}−Yₜ=[eₜ^{a},eₜ^{o}]∈ [symbol] ²

The pricing unit 114 may be configured for using the PID control algorithm. Finally, at time period t, the surge sₜ may be configured as

sₜ=sₜ₋₁+f dₜ+f sₜ

where

fdₜ=k_{P}^{a}(eₜ^{a}−eₜ₋₁^{a})+kₗ^{a}eₜ^{a}+k_{D}^{a}(eₜ^{a}−2eₜ₋₁^{a}+eₜ₋₂^{a})

fsₜ=k_{P}^{o}(eₜ^{o}−eₜ₋₁^{o})+kₗ^{o}eₜ^{o}+k_{D}^{o}(eₜ^{o}−2eₜ₋₁^{o}+eₜ₋₂^{o})

Thus, parameters of the pricing unit 114 may be adjusted

K_{P}=[k_{P}^{a},k_{P}^{o}]∈ [symbol] ^{1×2},Kₗ=[kₗ^{a},kₗ^{o}]∈ [symbol] ^{1×2}, and K_{D}=[k_{D}^{a},k_{D}^{o}]∈ [symbol] ^{1×2}

such that

$$min {\sum }_{t = 0}^{T} {{ω}_{1} ( {e}_{t}^{a} )}^{2} + {{ω}_{2} ( {e}_{t}^{o} )}^{2}$$

where ω₁ and ω₂ are the weights for allocation rate and occupancy rate, respectively.

This way, the configured P/(Proportional Integral) pricing unit 114 may respond to the allocation rate and the occupancy rate and, in addition, may also be responsive to a change of the allocation rate and the occupancy rate.

Further, ETA (estimated time of arrival) and FC (fare check counts) may be integrated to adjust the step size for allocation rate and occupancy rate, respectively, in case these are bigger than predetermined threshold values. Thus, analogously, the pricing unit 114 may be configured as

fdₜ=k_{P}^{a}(eₜ^{a}−eₜ₋₁^{a})+kₗ^{a}[1+sgn(eₜ^{a})·f^{a}(xₜ^{ETA})]DZ^{a}(eₜ^{a})

fsₜ=k_{P}^{o}(eₜ^{o}−eₜ₋₁^{o})+kₗ^{o}[1−sgn(eₜ^{o})·f^{o}(xₜ^{FC})]DZ^{o}(eₜ^{o})

where K_{P}^{a}>0, Kₗ^{a}>0, K_{P}^{o}<0, Kₗ^{o}<0

An underlying idea behind sgn(x), e.g. the sign function, may be—taking the fare check counts as an example for illustrating purpose (the same idea applies to ETA signal):

When the allocation rate is below a target or threshold value, e.g. eₜ^{a}>0, the surge is expected to increase. If there are more fare check records at period t, xₜ^{FC}>xₜ₋₁^{FC}, the surge is expected to increase faster. Under an extreme circumstance, if there are tremendous fare check records at period t, e.g. xₜ^{FC}>>xₜ₋₁^{FC} the surge is expected to increase at the maximal speed. However, if there are less fare check records at period t, e.g. xₜ^{FC}<xₜ₋₁^{FC} the surge is expected to increase slower. Under an extreme circumstance, if there is no fare check record at t, e.g. xₜ^{FC}=0, the surge is expected to remain unchanged.

Further, when the allocation rate is above a target, e.g. eₜ^{a}<0, the surge is supposed to be increased. If there are more fare check records at period t, xₜ^{FC}>xₜ₋₁^{FC} the surge is expected to increase slower. Under an extreme circumstance, if there are tremendous fare check records at period t, e.g. xₜ^{FC}>>xₜ₋₁^{FC} the surge is expected to remain unchanged. However, if there are less fare check records at period t, e.g. xₜ^{FC}<xₜ₋₁^{FC}, the surge is expected to increase faster. Under an extreme circumstance, if there is no fare check record at t, e.g. xₜ^{FC}=0, the surge is expected to increase at the maximal speed.

In various embodiments, a dead-zone (DZ) method may be used and configured such that the I(integral) part of the pricing unit 114 will not respond when the allocation rate and occupancy rate are close to their targets. In particular, the two dead-zone functions may be defined as

$${DZ}^{a} ( x ) = \{ \begin{matrix}{m}_{r}^{a} ( x - {δ}_{r}^{a} ) & x \geq {δ}_{r}^{a} \\ 0 & {δ}_{l}^{a} < x < {δ}_{r}^{a} \\ {m}_{l}^{a} ( x - {δ}_{l}^{a} ) & x \leq {δ}_{l}^{a}\end{matrix} for the allocation rate , and$$

$${DZ}^{o} ( x ) = \{ \begin{matrix}{m}_{r}^{o} ( x - {δ}_{r}^{a} ) & x \geq {δ}_{r}^{o} \\ 0 & {δ}_{l}^{o} < x < {δ}_{r}^{o} \\ {m}_{l}^{o} ( x - {δ}_{l}^{a} ) & x \leq {δ}_{l}^{o}\end{matrix} for the occupancy rate ,$$

with δᵣ^{a}≥0, δₗ^{a}≤0, δᵣ^{o}≥0, δₗ^{o}≤0 being breaking points and mᵣ^{a}, mₗ^{a}, mᵣ^{o}, mₗ^{o}>0 being slopes.

A first new signal ETA and a second new signal FC may be entered in two functions, which are defined as

$${f}^{a} ( x ) = \{ \begin{matrix}{f}_{0}^{a} ( {α}^{a} ( x - {x}_{d}^{ETA} ) ) , & if x \geq {x}_{d}^{ETA} \\ 0 & otherwise\end{matrix}$$

$${f}^{o} ( x ) = \{ \begin{matrix}{f}_{0}^{o} ( {α}^{o} ( log x - {x}_{d}^{FC} ) ) , & if x \geq {e}^{{x}_{d}^{FC}} \\ 0 & otherwise\end{matrix}$$

where α^{a}>0, α^{o}>x_{d}^{ETA}≥0, x\hat{ }FC_d≥0, and f₀^{a}(x) and f₀^{o}(x) should be configured such that

0≤f₀^{a}(x)<1,∀x≥0

0≤f₀^{o}(x)<1,∀x≥0

Thus, it follows:

fdₜ=max(fdₜ,fdₘₐᵢₙ)

fdₜ=min(fdₜ,fdₘₐₓ)

fsₜ=max(fsₜ,fsₘᵢₙ)

fsₜ=min(fsₜ,fsₘₐₓ)

Δsₜ=fdₜ+fsₜ

sₜ=sₜ₋₁+Δsₜ

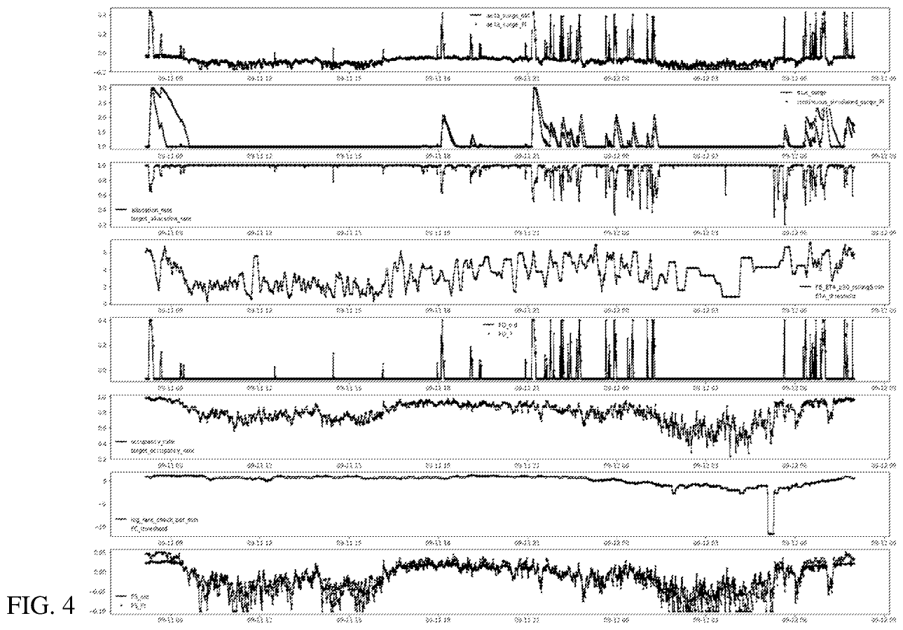

FIG. 4 illustrates results of a simulation of the pricing unit 114 according to various embodiments used to simulate market dynamics in a random residential area for illustration purpose. It can be observed that the signal produced by the new pricing unit 114 is less volatile, and therefore, the surge oscillation can be mitigated.

### Examples

In following, examples are described that illustrate various embodiments and are not intended to limit the scope.

Example 1 is a service pricing device, including a receiving unit configured to receive service orders over a communication network from a plurality of customers requesting a service from a service provider in a predetermined area and in a time period; an allocation unit configured to determine a current allocation rate of received service orders among a plurality of service contractors and to allocate received service orders to the plurality of service contractors, and a pricing unit configured for determining a current price for a service order received in the time period for the predetermined area based on the current allocation rate of service orders and a predetermined allocation rate of service orders for the plurality of service contractors, and a notification unit configured to provide the current price of the service over the communication network to the plurality of customers and to the plurality of service contractors such that a service order for the predetermined area and in the time period is fulfilled at the determined current price.

In Example 2, the subject matter of Example 1 optionally includes that each service order is configured as an electronic message optionally includes that the receiving unit includes a communication device configured to receive the electronic messages including the service orders via a communication connection through the communication network.

In Example 3, the subject matter of Example 1 or 2 optionally includes that the notification unit includes a communication device configured to transmit the determined current price for the service via communication connections through the communication network to the plurality of customers and to the plurality of service contractors.

In Example 4, the subject matter of anyone of Examples 1 to 3 optionally includes one or more processor(s), the processor(s) configured to host the allocation unit and the pricing unit.

In Example 5, the subject matter of anyone of Examples 1 to 3 optionally includes one or more application specific integrated circuit (ASIC), the one or more ASIC configured to host the allocation unit and the pricing unit.

In Example 6, the subject matter of anyone of Examples 1 to 5 optionally includes that the allocation unit is further configured to determine a current occupation rate of service contractors of the plurality of service contractors and wherein the pricing unit is further configured for determining the current price for the service order received in the time period for the predetermined area based on the current occupation rate of service contractors and a predetermined occupation rate for service contractors.

In Example 7, the subject matter of anyone of Examples 1 to 6 optionally includes that the predetermined area is a geohash code area, a postal code area or a radio cell area.

In Example 8, the subject matter of anyone of Examples 1 to 7 optionally includes that the time period has a period length in a range from 30 sec to about 2 h.

In Example 9, the subject matter of anyone of Examples 1 to 8 optionally includes that the time period is adjustable.

In Example 10, the subject matter of anyone of Examples 1 to 9 optionally includes that the service is a real space service.

Example 11 is a service pricing device including: one or more processor(s); and a memory having instructions stored therein, the instructions, when executed by the one or more processor(s), cause the one or more processor(s) to: receive service orders over a communication network from a plurality of customers requesting a service from a service provider in a predetermined area and in a time period; determine a current allocation rate of received service orders among a plurality of service contractors and allocate received service orders to the plurality of service contractors; determining a current price for a service order received in the time period for the predetermined area based on the current allocation rate of service orders and a predetermined allocation rate of service orders for the plurality of service contractors, and provide the current price of the service over the communication network to the plurality of customers and to the plurality of service contractors such that a service order for the predetermined area and in the time period is fulfilled at the determined current price.

In Example 12, the subject matter of Example 11 optionally includes that each service order is configured as an electronic message optionally includes that the receiving unit includes a communication device configured to receive the electronic messages including the service orders via a communication connection through the communication network.

In Example 13, the subject matter of Example 11 or 12 optionally includes that the notification unit includes a communication device configured to transmit the determined current price for the service via communication connections through the communication network to the plurality of customers and to the plurality of service contractors.

In Example 14, the subject matter of anyone of Examples 11 to 13 optionally includes one or more processors, the processor(s) configured to host the allocation unit and the pricing unit.

In Example 15, the subject matter of anyone of Examples 11 to 13 optionally includes one or more application specific integrated circuit (ASIC), the one or more ASIC configured to host the allocation unit and the pricing unit.

In Example 16, the subject matter of anyone of Examples 11 to 15 optionally includes that the allocation unit is further configured to determine a current occupation rate of service contractors of the plurality of service contractors and wherein the pricing unit is further configured for determining the current price for the service order received in the time period for the predetermined area based on the current occupation rate of service contractors and a predetermined occupation rate for service contractors.

In Example 17, the subject matter of anyone of Examples 11 to 16 optionally includes that the predetermined area is a geohash code area, a postal code area or a radio cell area.

In Example 18, the subject matter of anyone of Examples 11 to 17 optionally includes that the time period has a period length in a range from 30 sec to about 2 h.

In Example 19, the subject matter of anyone of Examples 11 to 18 optionally includes that the time period is adjustable.

In Example 20, the subject matter of anyone of Examples 11 to 19 optionally includes that the service is a real space service.

Example 21 is a service pricing method including receiving service orders over a communication network from a plurality of customers requesting a service from a service provider in a predetermined area and in a time period; determining a current allocation rate of received service orders among a plurality of service contractors and allocate received service orders to the plurality of service contractors, determining a current price for a service order received in the time period for the predetermined area based on the current allocation rate of service orders and a predetermined allocation rate of service orders for the plurality of service contractors, and providing the current price of the service over the communication network to the plurality of customers and to the plurality of service contractors such that a service order for the predetermined area and in the time period is fulfilled at the determined current price.

In Example 22, the subject matter of Example 21 optionally includes that each service order is configured as an electronic message optionally includes that the receiving unit includes a communication device configured to receive the electronic messages including the service orders via a communication connection through the communication network.

In Example 23, the subject matter of Example 21 or 22 optionally includes that the notification unit includes a communication device configured to transmit the determined current price for the service via communication connections through the communication network to the plurality of customers and to the plurality of service contractors.

In Example 24, the subject matter of anyone of Examples 21 to 23 optionally includes one or more processors, the processor(s) configured to host the allocation unit and the pricing unit.

In Example 25, the subject matter of anyone of Examples 21 to 23 optionally includes one or more application specific integrated circuit (ASIC), the one or more ASIC configured to host the allocation unit and the pricing unit.

In Example 26, the subject matter of anyone of Examples 21 to 25 optionally includes that the allocation unit is further configured to determine a current occupation rate of service contractors of the plurality of service contractors and wherein the pricing unit is further configured for determining the current price for the service order received in the time period for the predetermined area based on the current occupation rate of service contractors and a predetermined occupation rate for service contractors.

In Example 27, the subject matter of anyone of Examples 21 to 26 optionally includes that the predetermined area is a geohash code area, a postal code area or a radio cell area.

In Example 28, the subject matter of anyone of Examples 21 to 27 optionally includes that the time period has a period length in a range from 30 sec to about 2 h.

In Example 29, the subject matter of anyone of Examples 21 to 28 optionally includes that the time period is adjustable.

In Example 30, the subject matter of anyone of Examples 21 to 29 optionally includes that the service is a real space service.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A service pricing device, comprising,
a receiving unit configured to receive service orders over a communication network from a plurality of customers requesting a service from a service provider in a predetermined area and in a time period;
an allocation unit configured to determine a current allocation rate of received service orders among a plurality of service contractors and to allocate received service orders to the plurality of service contractors; and
a pricing unit configured for determining a current price for a service order received in the time period for the predetermined area based on a surge value, and
a notification unit configured to provide the current price of the service over the communication network to the plurality of customers and to the plurality of service contractors such that the service order for the predetermined area and in the time period is fulfilled at the determined current price,
wherein the pricing unit configures the surge value applied on the current price, based on a change of the current allocation rate and a difference between the current allocation rate and a predetermined allocation rate.

2. The service pricing device of claim 1, wherein each service order is configured as an electronic message, wherein the receiving unit comprises a communication device configured to receive the electronic messages comprising the service orders via a communication connection through the communication network.

3. The service pricing device of claim 1, wherein the notification unit comprises a communication device configured to transmit the determined current price for the service via communication connections through the communication network to the plurality of customers and to the plurality of service contractors.

4. The service pricing device of claim 1,
one or more processor(s), the processor(s) configured to host the allocation unit and the pricing unit.

5. The service pricing device of claim 1,
one or more application specific integrated circuit (ASIC), the one or more ASIC configured to host the allocation unit and the pricing unit.

6. The service pricing device of claim 1, further comprising
an occupancy unit configured to determine a current occupation rate of service contractors of the plurality of service contractors currently not available for accepting a service order among the plurality of service contractors and wherein the pricing unit is further configured for determining the current price for the service order received in the time period for the predetermined area based on the current occupation rate of service contractors and a predetermined occupation rate for service contractors.

7. The service pricing device of claim 1,
wherein the predetermined area is a geohash code area, a postal code area or a radio cell area.

8. The service pricing device of claim 1,
wherein the time period has a period length in a range from 30 sec to about 2 h.

9. The service pricing device of claim 1,
wherein the time period is adjustable.

10. The service pricing device of claim 1,
wherein the service is a real space service.

11. A service pricing device, comprising:
one or more processor(s); and
a memory having instructions stored therein, the instructions, when executed by the one or more processor(s), cause the one or more processor(s) to:
receive service orders over a communication network from a plurality of customers requesting a service from a service provider in a predetermined area and in a time period,
determine a current allocation rate of received service orders among a plurality of service contractors and allocate received service orders to the plurality of service contractors,
determine a current price for a service order received in the time period for the predetermined area based on a surge value,
configure the surge value applied on the current price, based on a change of the current allocation rate and a difference between the current allocation rate and a predetermined allocation rate, and
provide the current price of the service over the communication network to the plurality of customers and to the plurality of service contractors such that the service order for the predetermined area and in the time period is fulfilled at the determined current price.

12. A service pricing method, comprising:
receiving service orders over a communication network from a plurality of customers requesting a service from a service provider in a predetermined area and in a time period;
determining a current allocation rate of received service orders among a plurality of service contractors and allocate received service orders to the plurality of service contractors;
determining a current price for a service order received in the time period for the predetermined area based on a surge value;
configuring the surge value applied on the current price, based on a change of the current allocation rate and a difference between the current allocation rate and a predetermined allocation rate; and
providing the current price of the service over the communication network to the plurality of customers and to the plurality of service contractors such that the service order for the predetermined area and in the time period is fulfilled at the determined current price.
